(19) United States
(12) Patent Application Publication
(10) Pub. No.: US 2023/0127065 A1
(43) Pub. Date: Apr. 27, 2023

(54) Concrete Sandwich Composite Structure With Ultra-High Performance Concrete Wrapped Steel Tube

(71) Applicant: Guangzhou Municipal Engineering Design and Research Institute Co., Ltd., Guangzhou (CN)

(72) Inventors: Pinghua Ning, Guangzhou (CN); Xiaogang Yue, Guangzhou (CN); Fei Guo, Guangzhou (CN); Huiyong Hu, Guangzhou (CN); Sheng Wang, Guangzhou (CN); Yu Zhou, Guangzhou (CN); Songtao Zhang, Guangzhou (CN); Jiongkun Zeng, Guangzhou (CN)

(21) Appl. No.: 17/974,319

(22) Filed: Oct. 26, 2022

(30) Foreign Application Priority Data
Oct. 27, 2021 (CN) 202110959282.8

(51) Int. Cl. E04C 3/46; E04C 5/06; E04C 5/16

(52) U.S. Cl. CPC E04C 3/46; E04C 5/06; E04C 5/168

(57) ABSTRACT

A concrete sandwich composite structure of an ultra-high performance concrete wrapped steel tube includes a steel arch, a plurality of connecting members and an ultra-high performance concrete layer. The plurality of connecting members are arranged on an outer wall of the steel arch at intervals, and one end of each connecting member is fixedly connected with the outer wall of the steel arch; and the ultra-high performance concrete layer is arranged on the outer wall of the steel arch and connected with the outer wall of the steel arch through the connecting members, and the ultra-high performance concrete layer can effectively prevent water from being contacted with the steel arch, so that a durability of the steel arch is improved, and an isolating agent is further arranged between the ultra-high performance concrete layer and the outer wall of the steel arch, and an elongated shear nail in the connecting member is wrapped by rubber, so that the interaction between the ultra-high performance concrete layer and a main body structure of the steel arch can be reduced, the effects of releasing a stress of the ultra-high performance concrete layer and reducing a thickness are achieved, and plain concrete can be poured into the steel arch to improve an anti-collision performance.

### CROSS-REFERENCE TO RELATED APPLICATION

This application claims priority to Chinese Patent Application No. 202110959282.8 filed Oct. 27, 2021, the disclosure of which is hereby incorporated by reference in its entirety.

### BACKGROUND

### Technical Field

The disclosure relates to the technical field of bridge, and particularly to a concrete sandwich composite structure of an ultra-high performance concrete wrapped steel tube.

### Technical Description

For a long-span bridge structure across river and ocean, when it is necessary to arrange a steel arch in water due to restrictions by a site, a geological condition, a structural stress, a landscape and the like, there is an inevitable problem of steel structure corrosion. Improper treatment of the corrosion problem easily leads to material damage and facility function failure, and further leads to structural damage of engineering facilities and shortens a service life of the structure, thus posing a major threat to people's lives and properties.

In addition, in a navigable river basin, when a ship directly hits the steel arch, it is easy to cause safety accidents, casualties and economic losses due to a low rigidity of a steel structure and a poor anti-collision performance. In the existing technology, an anti-collision facility is often additionally arranged outside the steel arch, which not only has a high cost, but also occupies a part of a river channel, thus affecting navigation and flood discharge, and having a poor landscape effect.

### SUMMARY

The disclosure aims to solve at least one of the technical problems in the existing technology, and provide a concrete sandwich composite structure of an ultra-high performance concrete wrapped steel tube, which is simple in construction, wherein a steel arch is wrapped by ultra-high performance concrete with excellent mechanical performance and durability, which can greatly reduce an influence of a water level change on the steel arch, and meanwhile, a high compactness and a good working performance of the structure make a concrete layer have a high crack resistance, an ultra-high compression resistance and a high fatigue limit, which is beneficial for improving an anti-collision performance and a service life of the steel arch, can effectively solve anti-corrosion and anti-collision problems of the steel arch in water, and is convenient to construct, so that coating maintenance of the steel arch in water is reduced during a later operation period, and good technical and economic benefits are achieved.

In a first aspect of the disclosure, a concrete sandwich composite structure of an ultra-high performance concrete wrapped steel tube is provided, which comprises a steel arch; a plurality of connecting members, wherein the plurality of connecting members are arranged on an outer wall of the steel arch at intervals, and one end of each of the connecting members is fixedly connected with the outer wall of the steel arch; and an ultra-high performance concrete layer, wherein the ultra-high performance concrete layer is arranged on the outer wall of the steel arch, the ultra-high performance concrete layer is connected with the outer wall of the steel arch through the connecting members, and an isolating agent is arranged between the ultra-high performance concrete layer and the outer wall of the steel arch.

The concrete sandwich composite structure of an ultra-high performance concrete wrapped steel tube of the disclosure has at least the following beneficial effects. In this non-limiting embodiment, The ultra-high performance concrete layer is arranged on the outer wall of the steel arch, so that the ultra-high performance concrete layer is wrapped outside the steel arch to prevent the steel arch from being corroded in water, and an anti-collision ability of the steel arch can also be improved at the same time, and in addition, the plurality of connecting members are arranged between the outer wall of the steel arch and the concrete at intervals, and one end of the connecting member is fixed on the outer wall of the steel arch and the other end of the connecting member is arranged inside the ultra-high performance concrete layer, so that the outer wall of the steel arch is firmly connected with the ultra-high performance concrete layer in an axial direction. An outer wall plate is provided with the isolating agent, which is used for reducing an interaction between the ultra-high performance concrete layer and a main structure of the steel arch, reducing a stress of the ultra-high performance concrete layer, reducing a thickness and improving an economic benefit, and can further improve water resistance of the steel arch.

According to the concrete sandwich composite structure of an ultra-high performance concrete wrapped steel tube in the first aspect of the disclosure, the connecting member includes an elongated shear nail and rubber, and the rubber wraps outside the elongated shear nail. The shear nail has a small rigidity in a shear force direction and may deform under a shear force action, the rubber which wraps outside the shear nail has a certain deformation ability, and the combination of the shear nail and the rubber may adapt to a relative displacement between the ultra-high performance concrete layer and the steel arch, reduce a stress of a main structure in which the ultra-high performance concrete is involved and reduce a thickness of the ultra-high performance concrete layer, thus improving an economic benefit. In addition, the rubber wraps outside the shear nail, which can protect the shear nail, so as to prevent the shear nail from being corroded.

According to the concrete sandwich composite structure of an ultra-high performance concrete wrapped steel tube in the first aspect of the disclosure, the steel arch has a box structure, the steel arch includes an outer wall plate and a web plate, the web plate is arranged in an inner cavity surrounded by the outer wall plate, and two ends of the web plate are fixedly connected with the outer wall plate. The web plate has supporting and strengthening effects on the outer wall plate, which can improve a stability of the steel arch.

According to the concrete sandwich composite structure of an ultra-high performance concrete wrapped steel tube in the first aspect of the disclosure, a plurality of stiffening ribs are further arranged in the steel arch, and the stiffening ribs are fixedly arranged on an inner wall of the outer wall plate and the web plate at intervals. The stiffening ribs are fixedly arranged on the inner wall of the outer wall plate and the web plate at intervals, which can improve a stability and a torsion resistance of the steel arch, thus being beneficial for an anti-collision ability of the steel arch and improving a safety performance of a bridge.

According to the concrete sandwich composite structure of an ultra-high performance concrete wrapped steel tube in the first aspect of the disclosure, the isolating agent is made of polyurethane, which can reduce an interaction between the ultra-high performance concrete layer and the main structure of the steel arch, the polyurethane has good corrosion resistance, aging resistance and water resistance at the same time, which can further improve a corrosion resistance of the steel arch and prolong a service life of the steel arch, and moreover, the polyurethane has strong adhesion to metal, which can better adhere to the steel arch to protect the steel arch.

According to the concrete sandwich composite structure of an ultra-high performance concrete wrapped steel tube in the first aspect of the disclosure, a plurality of reinforcing steel bars are arranged in the ultra-high performance concrete layer, and the reinforcing steel bars are vertically and horizontally arranged at intervals to form a net structure of the reinforcing steel bars, which can improve anchorage of the steel bars to the concrete, make a load borne by the concrete layer evenly spread and distribute, be beneficial for improving an anti-shattering performance of a concrete layer structure to effectively protect the steel arch and reduce an influence of an external environment on the steel arch, thus prolonging a service life of the steel arch.

According to the concrete sandwich composite structure of an ultra-high performance concrete wrapped steel tube in the first aspect of the disclosure, plain concrete is poured into the steel arch, which can increase an overall rigidity of the structure and strengthen the anti-collision ability of the steel arch, thus improving the safety performance of the bridge.

Additional aspects and advantages of the disclosure will be explained in part in the following description, which can become apparent from the following description or be understood through practice of the disclosure.

### BRIEF DESCRIPTION OF THE DRAWINGS

The disclosure is further described hereinafter with reference to the drawings and the non-limiting embodiments.

FIG. 1 is a stereoscopic diagram of a non-limiting embodiment of a concrete sandwich composite structure of an ultra-high performance concrete wrapped steel tube according to the principles of the present disclosure;

FIG. 2 is a locally enlarged view of a part A in FIG. 1;

FIG. 3 is a top view of FIG. 1;

FIG. 4 is a sectional view of FIG. 1;

FIG. 5 is a locally enlarged view of a part B in FIG. 4; and

FIG. 6 is a locally structural diagram of a connecting member in FIG. 1.

Reference Numerals:

100 refers to steel arch; 110 refers to outer wall plate; 120 refers to web plate; 130 refers to stiffening rib; 140 refers to plain concrete; 150 refers to isolating agent;

200 refers to connecting member; 210 refers to shear nail; 220 refers to rubber;

300 refers to ultra-high performance concrete layer; and 310 refers to steel bar.

### DETAILED DESCRIPTION

The specific and non-limiting embodiments of the disclosure will be described in detail are shown in the drawings. The drawings are intended to supplement the description in the written portion of the specification with figures, so that people can intuitively and vividly understand each technical feature and the overall technical solution of the disclosure, but it should not be understood as a limitation to the scope of protection of the disclosure.

In the description of the disclosure, it should be understood that the orientation or position relation related to the orientation description, such as the orientation or position relation indicated by the terms “upper”, “lower”, “front”, “rear”, “left”, “right”, etc., is based on the orientation or position relation shown in the drawings, which is only used for convenience of description of the disclosure and simplification of description instead of indicating or implying that the indicated device or element must have a specific orientation, and be constructed and operated in a specific orientation, and thus should not be understood as a limitation to the disclosure.

In the description of the disclosure, the meaning of several refers to being one or more, and the meaning of multiple refers to being two or more. The meanings of greater than, less than, more than, etc., are understood as not including the number that follows, while the meanings of above, below, within, etc., are understood as including the number that follows. If there is the description of first and second, it is only for the purpose of distinguishing between technical features, and should not be understood as indicating or implying relative importance, implicitly indicating the number of the indicated technical features or implicitly indicating the order of the indicated technical features.

In the description of the disclosure, unless otherwise explicitly defined, the terms “setting”, “installing” and “connecting” should be understood a broad sense, and those having ordinary skills in the art can reasonably determine the specific meanings of the above terms in the disclosure in combination with the specific contents of the technical solution.

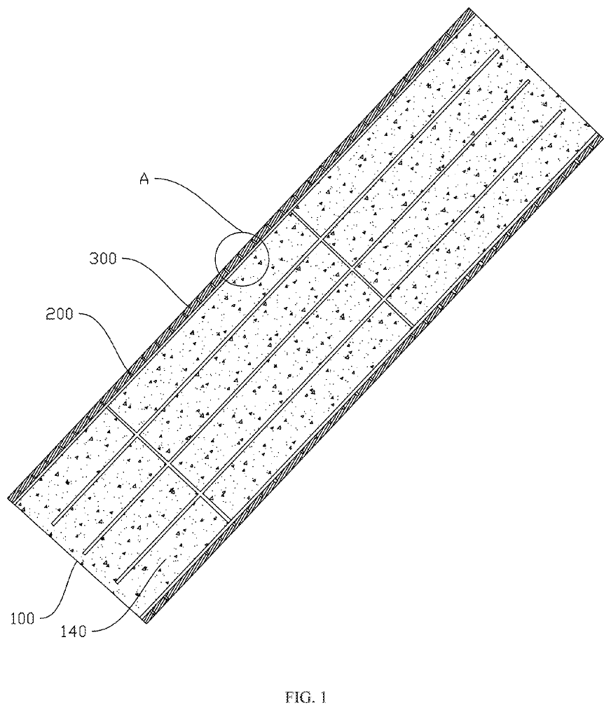

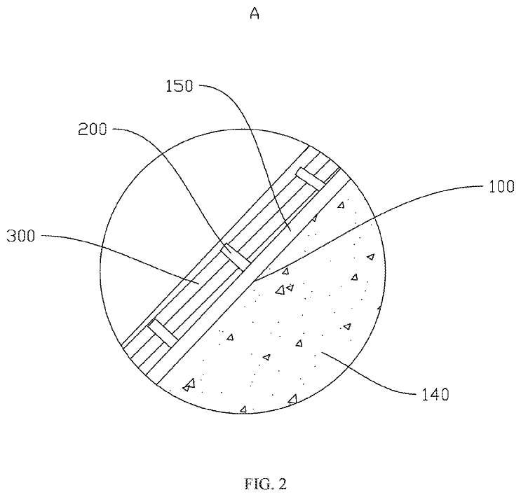

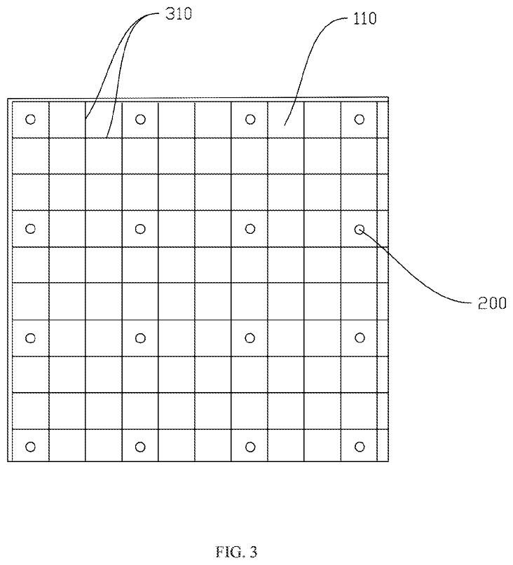

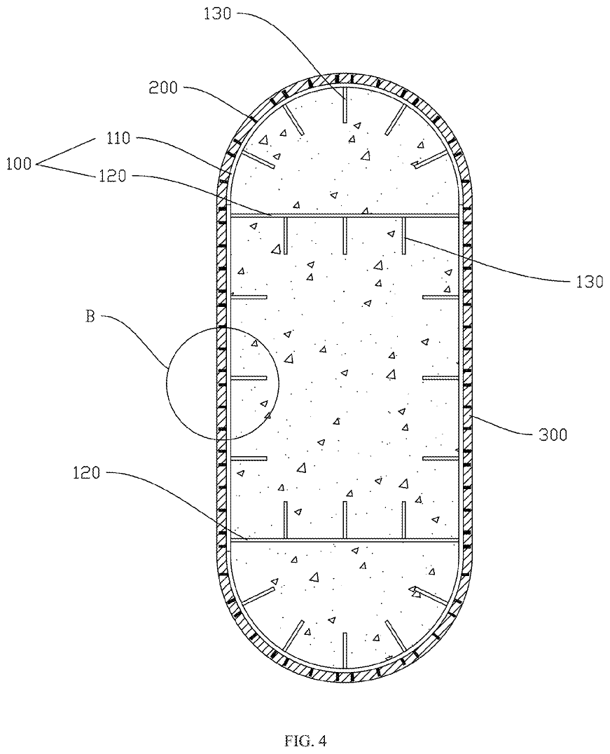

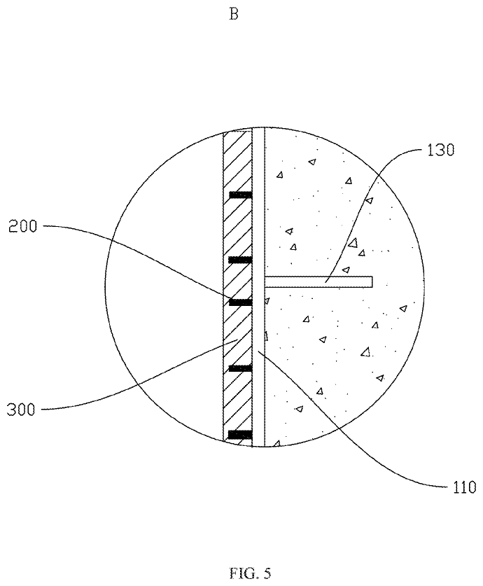

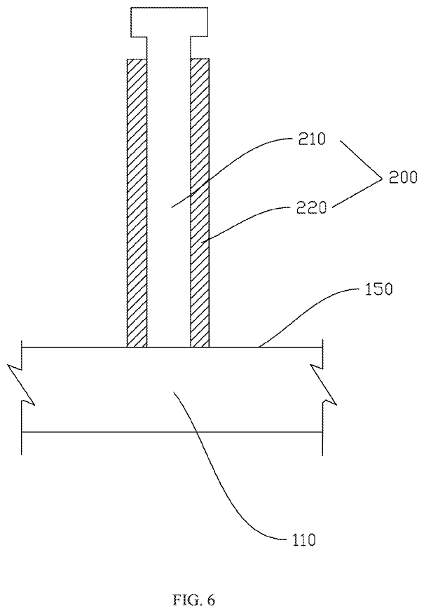

With reference to FIG. 1 to FIG. 6, a non-limiting embodiment of the disclosure provides a concrete sandwich composite structure of an ultra-high performance concrete wrapped steel tube, which comprises a steel arch 100, connecting members 200, an ultra-high performance concrete layer 300, an isolating agent 150 and plain concrete 140.

The ultra-high performance concrete layer 300 is arranged on an outer wall of the steel arch 100, so that the ultra-high performance concrete layer 300 is wrapped outside the steel arch 100 to prevent the steel arch 100 from being corroded in water, and an anti-collision ability of the steel arch 100 can also be improved at the same time. In addition, the plurality of connecting members 200 are arranged between the outer wall of the steel arch 100 and the ultra-high performance concrete layer 300 at intervals, and one end of the connecting member 200 is fixed on the outer wall of the steel arch 100 and the other end of the connecting member is arranged inside the ultra-high performance concrete layer 300, so that the outer wall of the steel arch is firmly connected with the ultra-high performance concrete layer 300 in an axial direction, thus increasing a connection strength between the steel arch 100 and the ultra-high performance concrete layer 300. An outer wall plate 110 is provided with the isolating agent 150, which is used for reducing an interaction between the ultra-high performance concrete layer 300 and a main structure of the steel arch 100, reducing a stress of the ultra-high performance concrete layer 300, reducing a thickness and improving an economic benefit, and can also improve water resistance of the steel arch 100.

Further, the connecting member 200 includes an elongated shear nail 210 and rubber 220, wherein the rubber 220 wraps outside the elongated shear nail 210, the elongated shear nail 210 has the advantage of high-strength axial connection, and one end of the elongated shear nail 210 is fixed on the outer wall of the steel arch 100 and the other end of the elongated shear nail is arranged in the ultra-high performance concrete layer 300, so that the outer wall of the steel arch 100 is firmly connected with the ultra-high performance concrete layer 300 in an axial direction. The elongated shear nail 210 has a small rigidity in a shear force direction and may deform under an elongated shear force action, and the rubber 220 which wraps outside elongated shear nail 210 has a certain deformation capacity. The combination of the shear nail and the rubber may adapt to a relative displacement between the ultra-high performance concrete layer 300 and the steel arch 100, reduce a stress of a main structure in which the ultra-high performance concrete layer 300 is involved and reduce a thickness of the ultra-high performance concrete layer 300, thus improving an economic benefit. In addition, the rubber 220 wraps outside the elongated shear nail 210, which can protect the elongated shear nail 210, so as to prevent the elongated shear nail 210 from being corroded.

Further, the steel arch 100 has a box structure, the steel arch 100 includes an outer wall plate 110 and a web plate 120, the web plate 120 is arranged in an inner cavity surrounded by the outer wall plate 110, and two ends of the web plate 120 are fixedly connected with the outer wall plate 110. The web plate 120 has supporting and strengthening effects on the outer wall plate 110, which can improve a stability of the steel arch 100.

Further, a plurality of stiffening ribs 130 are arranged in the steel arch 100, and the stiffening ribs 130 are fixedly arranged on the inner wall of the outer wall plate 110 and the web plate 120 at intervals, which can improve a stability and a torsion resistance of the steel arch 100, thus improving a safety performance of a bridge.

Further, the isolating agent 150 is made of polyurethane, which can reduce an interaction between the ultra-high performance concrete layer and the main structure of the steel arch, and the polyurethane has good corrosion resistance, aging resistance and water resistance at the same time, which can further improve a corrosion resistance and an anti-shaking performance of the steel arch 100 and prolong a service life of the steel arch 100 due to the aging resistance. Moreover, the polyurethane has strong adhesion to metal, which can better adhere to the steel arch 100 to protect the steel arch 100.

Further, a plurality of reinforcing steel bars 310 are arranged in the ultra-high performance concrete layer 300, and the reinforcing steel bars 310 are vertically and horizontally arranged at intervals to form a net structure of the reinforcing steel bars 310, which can improve anchorage of the steel bars 310 to the concrete, make a load borne by the ultra-high performance concrete layer 300 evenly spread and distribute, be beneficial for improving an anti-shattering performance of a structure of the ultra-high performance concrete layer 300 to effectively protect the steel arch 100 and reduce an influence of an external environment on the steel arch 100, thus prolonging a service life of the steel arch 100.

Further, the plain concrete 140 is poured into the steel arch 100, which can increase an overall rigidity of the structure and strengthen the anti-collision ability of the steel arch 100, thus improving the safety performance of the bridge. It should be noted that, when the steel arch has a risk of collision with a ship, the plain concrete 140 is poured into the steel arch 100, and when the steel arch has no risk of collision with the ship, whether the plain concrete 140 needs to be poured may be determined according to an actual situation.

The plain concrete 140 is poured into the steel arch 100, which can improve the overall rigidity of the structure and improve the anti-collision performance; while a periphery of the steel arch 100 is wrapped with the ultra-high performance concrete, which has excellent anti-collision and anti-corrosion effects by using ultra-high mechanical performance and durability of the steel arch. Meanwhile, by using the elongated shear nail 210 wrapped with the rubber 220, and coating an outer surface of the steel arch 100 with the isolating agent 150, a stress of a main structure in which the ultra-high performance concrete layer 300 is not involved can be reduced, reducing a thickness of the ultra-high performance concrete layer 130 and improving an economic benefit.

The disclosures further provides a method for assembly construction: during construction, the steel arch 100 is processed in a prefabrication factory first, the connecting members 200 are welded, then a template is erected, the steel bars 310 are arranged and the outer ultra-high performance concrete layer 300 is poured integrally, high-temperature steam curing is carried out, and then the steel arch is transported to the site and segments of the steel arch 100 are welded, while the outer ultra-high performance concrete layer 300 is connected by a wet joint. After construction of the steel arch 100 is completed, the plain concrete 140 is directly poured into the steel arch 100 finally, so that the construction is convenient.

In the description of the disclosure, the descriptions with reference to the terms “one embodiment”, “some embodiments”, “schematic embodiments”, “examples”, “specific examples”, or “some examples” refer to that the specific features, structures, materials, or characteristics described in combination with the embodiment or example are included in at least one embodiment or example of the disclosure. In the specification, the schematic representation of the above terms does not necessarily mean the same embodiment or example. Moreover, the specific features, structures, materials or characteristics described may be combined in any one or more embodiments or examples in a suitable manner.

Although the embodiments of the disclosure have been shown and described, those having ordinary skills in the art may understand that various changes, modifications, substitutions and variations may be made to these embodiments without departing from the principle and purpose of the disclosure, and the scope of the disclosure is defined by the claims and their equivalents.

1. A concrete sandwich composite structure of an ultra-high performance concrete wrapped steel tube, comprising:
a steel arch;
a plurality of connecting members, wherein the plurality of connecting members are arranged on an outer wall of the steel arch at intervals, and one end of each of the connecting members is fixedly connected with the outer wall of the steel arch; and
an ultra-high performance concrete layer, wherein the ultra-high performance concrete layer is arranged on the outer wall of the steel arch, the ultra-high performance concrete layer is connected with the outer wall of the steel arch through the connecting members, and an isolating agent is arranged between the ultra-high performance concrete layer and the outer wall of the steel arch.

2. The concrete sandwich composite structure of an ultra-high performance concrete wrapped steel tube according to claim 1, wherein the connecting member comprises an elongated shear nail and a rubber wrapping outside the elongated shear.

3. The concrete sandwich composite structure of an ultra-high performance concrete wrapped steel tube according to claim 1, wherein the steel arch has a box structure, the steel arch comprises an outer wall plate and a web plate, the web plate is arranged in an inner cavity surrounded by the outer wall plate, and two ends of the web plate are fixedly connected with the outer wall plate.

4. The concrete sandwich composite structure of an ultra-high performance concrete wrapped steel tube according to claim 3, wherein a plurality of stiffening ribs are further arranged in the steel arch, and the stiffening ribs are fixedly arranged on an inner wall of the outer wall plate and the web plate at intervals.

5. The concrete sandwich composite structure of an ultra-high performance concrete wrapped steel tube according to claim 1, wherein the isolating agent is made of polyurethane.

6. The concrete sandwich composite structure of an ultra-high performance concrete wrapped steel tube according to claim 1, wherein a plurality of reinforcing steel bars are arranged in the ultra-high performance concrete layer, and the reinforcing steel bars are vertically and horizontally arranged at intervals to form a net structure of the reinforcing steel bars.

7. The concrete sandwich composite structure of an ultra-high performance concrete wrapped steel tube according to claim 1, wherein plain concrete is further poured into the steel arch.
